(19) United States
(12) Patent Application Publication
(10) Pub. No.: US 2013/0046410 A1
(43) Pub. Date: Feb. 21, 2013

(54) METHOD FOR CREATING VIRTUAL ENVIRONMENTAL SENSOR ON A POWER DISTRIBUTION UNIT

(71) Applicants: Hung-Ming HSIEH, Taipei (TW); Hsien-Hsun LIU, Taipei (TW); Hung-Chun CHIEN, Taipei (TW); Wen-Shuo CHUANG, Taipei (TW)

(72) Inventors: Hung-Ming HSIEH, Taipei (TW); Hsien-Hsun LIU, Taipei (TW); Hung-Chun CHIEN, Taipei (TW); Wen-Shuo CHUANG, Taipei (TW)

(73) Assignee: CYBER POWER SYSTEMS INC., Taipei (TW)

(21) Appl. No.: 13/212,606

(22) Filed: Aug. 18, 2011

(51) Int. Cl. G05D 23/19

(52) U.S. Cl. 700/277

(57) ABSTRACT

A method for creating virtual environmental sensor on a power distribution unit is executed by a power distribution unit and has steps of connecting to a network and at least one power-consuming device, searching all environmental sensors through the network, receiving environmental condition messages sent from each environmental sensor, presenting at least one environmental condition range to determine if the environmental condition messages sent from each environmental sensor are out of one of the at least one environmental condition range, and powering on or off a corresponding power-consuming device when each environmental condition message is out of a corresponding environmental condition range. Using the method can create remote environmental sensors networked with the PDU and solve the expansion restriction, spatial limitation and intractable wiring arising from the environmental sensor embedded in the conventional PDU in the form of hardware.

### BACKGROUND OF THE INVENTION

1. Field of the Invention

The present invention relates to a method for creating virtual environmental sensor on a power distribution unit (PDU), and more particularly to a method that receives messages sensed from external environmental sensors networked with a power distribution unit, determines if the sensed messages are out of bound respectively, and controls the PDU to start or stop supplying power to power-consuming devices connected with the PDU.

2. Description of the Related Art

Power management at regular remote sites, in particular those designed to accommodate computer equipment, heavily relies on the monitoring and control of environmental condition information. Equipment in such type of remote sites is sensitive to many environmental conditions, such as temperature, humidity and the like. These environmental conditions are judged for activating or deactivating corresponding equipment. For example, when temperature in a remote site is detected to be above an upper temperature bound by a temperature sensor, air conditioners in the remote site are automatically powered on to lower the temperature, and when the humidity in a remote site is detected to be above an upper humidity bound by a humidity sensor, dehumidifiers in the remote site are powered on to adjust the humidity in the remote site. Based on safety concern, additional items may be monitored and controlled as well. For example, smoke detectors are used to detect dense smoke in a data center, and emergency smoke exhaust fans are automatically turned on to evacuate the smoke, and when door intrusion is detected by a door sensor, an alarm is triggered immediately. The temperature sensors, humidity sensors, smoke detectors and door sensors as a whole are commonly termed as environmental sensors.

To most remote sites, control of the foregoing environmental sensors is implemented by informing a master control center of environmental conditions sensed by the environmental sensors at each remote site and determining if commands need to be issued from the master control center to respective remote sites. Such centralized monitoring model is feasible only if on-site personnel is on duty at the master control center around the clock and the manager of the master control center can go to the remote site to solve the problem there. For a large corporation such centralized monitoring model presents no difficulty as far as human resource is concerned. However, for small to medium size companies there is usually no one left on night shift after work, so the centralized monitoring model is hard to be fulfilled by companies of such scale.

To solve the foregoing issue, PDUs having environmental sensors built therein start emerging in the market to meet that end. The PDUs are connected to a power source and an uninterruptible power system (UPS) and each PDU has multiple power sockets thereon to acquire operating power for various power-consuming devices plugged therein. The PDUs having embedded environmental sensors are advantageous in directly activating specific power-consuming devices plugged in the PDUs when each environmental sensor detects an abnormal environmental condition. For example, for a PDU built in with a temperature sensor and controlling power of an air conditioner, when detecting an ambient temperature is above an upper temperature bound, the temperature sensor sends a message to the PDU so that the PDU can directly power on the air conditioner to adjust the temperature without requiring the remote control from the master control center. However, the embedded environmental sensors of such PDUs lack flexibility in terms of future expansion because such PDUs have their size finalized prior to shipment, limiting the number of temperature sensors and/or humidity sensors. Moreover, the success of mounting most environmental sensors significantly depends on the mounting location. For example, a door sensor must be mounted on a door, and a smoke detector must be mounted on a ceiling. The environmental sensors implemented inside the PDUs in the form of hardware tend to become bulky, and thus mounting the PDUs may be problematic or infeasible due to a restricting spatial condition and intractable wiring requirement (in the case that long wires are required).

### SUMMARY OF THE INVENTION

An objective of the present invention is to provide a method for creating virtual environmental sensor on a power distribution unit, which receives messages sensed from external environmental sensors networked with a PDU, determines if the sensed messages are out of bound respectively, and controls the PDU to start or stop supplying power to power-consuming devices connected with the PDU.

To achieve the foregoing objective, the method is executed by a PDU and has steps of:

connecting to a network and at least one power-consuming device;

searching all environmental sensors connected to the network and mapping each environmental sensor to one of the at least one power-consuming device;

receiving environmental condition messages sent from each environmental sensor;

presenting at least one environmental condition range to determine if the environmental condition messages sent from each environmental sensor are out of one of the at least one environmental condition range; and

powering on or off the power consuming device corresponding to the environmental sensor sending the environmental condition message when each environmental condition message is out of a corresponding environmental condition range.

Preferably, the power distribution unit provides a web page for multiple computers to connect with and browse the web page through the network, and the web page has a new equipment tab, an equipment list tab and a setting tab. The new equipment tab has a new equipment field for inputting identification information of a new environmental sensor. The equipment list tab lists the environmental sensors connected with the power distribution unit. The setting tab has a setting column for respectively setting the at least one temperature range and for determining if each environmental condition message is out of a corresponding temperature range.

The method of the present invention enables the PDU to connect with environmental sensors in a non-specific quantity, such as temperature sensor, humidity sensor and the like, to acquire environmental condition messages, such as temperature, humidity and the like, sensed by the environmental sensors. When the acquired environmental condition messages are irregular (for example, excessively high temperature or humidity), each corresponding power-consuming device (an air conditioner or a dehumidifier) is powered on. As new environmental sensors can be added by a web page of the PDU and the addition is completed by the PDU to handshake the added environmental sensors through a network, environmental sensors can be easily and flexibly expanded. As all environmental sensors are externally networked with the PDU, mounting the PDU is convenient and is not limited by spatial concern and intractable wiring.

Other objectives, advantages and novel features of the invention will become more apparent from the following detailed description when taken in conjunction with the accompanying drawings.

### BRIEF DESCRIPTION OF THE DRAWINGS

FIG. 1 is a schematic view of a system architecture having a PDU and multiple environmental sensors in accordance with the present invention;

FIG. 2 is a flow diagram of a method for creating virtual environmental sensor on a power distribution unit in accordance with the present invention;

FIG. 3 is a schematic view of a first web page provided by the power distribution unit in FIG. 1;

FIG. 4 is a schematic view of a second web page provided by the power distribution unit in FIG. 1;

FIG. 5A is a schematic view of a left part of a third web page provided by the power distribution unit in FIG. 1; and

FIG. 5B is a schematic view of a right part of a third web page provided by the power distribution unit in FIG. 1.

### DETAILED DESCRIPTION OF THE INVENTION

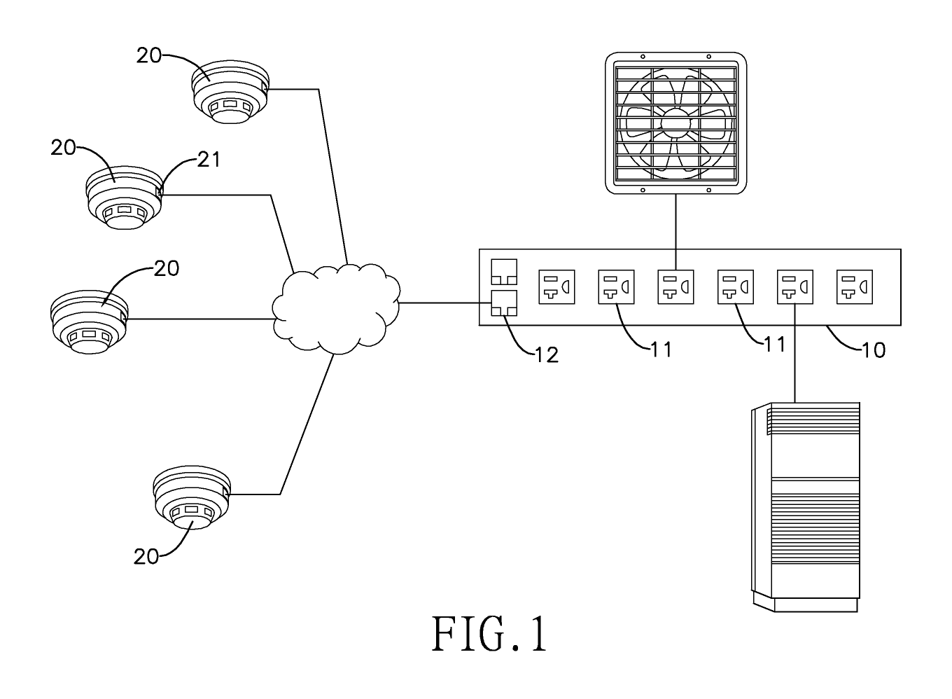

With reference to FIG. 1, a system architecture having a PDU and multiple environmental sensors in accordance with the present invention has at least one power distribution unit (PDU) 10 and at least one environmental sensor 20 respectively networked with the at least one PDU 10.

Each one of the at least one PDU 10 has multiple power sockets 11 and at least one network port 12. Each power socket 11 serves to be connected with a power-consuming device and is controlled by the PDU 10 to power on or power off the power-consuming device. The network port 12 serves to be connected to a wireline or wireless network, such as LAN, WLAN and the like, using a wireline or wireless network protocol, such as WiFi, ZIGBEE and the like.

Each one of the at least one environmental sensor 20 is a sensor for sensing a specific environmental condition, such as a temperature sensor, a humidity sensor, a smoke detector, a door sensor (for example a reed switch) or the like. Besides having a sensing chip or a circuit module having a specific sensing function, the environmental sensor 20 further has a network port 21 to be connected to a network to send sensed environmental condition messages through the network. Similar to the network port of the PDU 10, the network port 21 of the environmental sensor 20 serves to be connected to a wireline or wireless network, such as LAN, WLAN and the like, using a wireline or wireless network protocol, such as WiFi, ZIGBEE and the like.

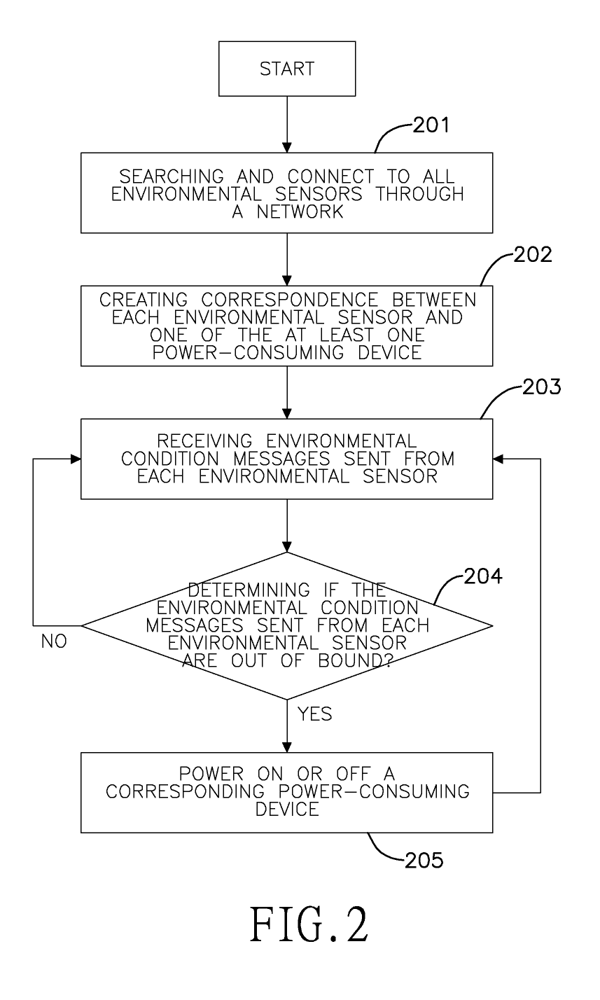

With reference to FIG. 2, after each one of the at least one PDU 10 is connected to a network and at least one power-consuming device, a method for creating virtual environmental sensor on a PDU is executed by the PDU 10 and has the following steps.

Search all environmental sensors connected to the network (201) and map each environmental sensor to one of the at least one power-consuming device (202).

Receive environmental condition messages sent from each environmental sensor (203).

Present at least one environmental condition range to determine if the environmental condition messages sent from each environmental sensor are out of one of the at least one environmental condition range (204).

Power on or off the power consuming device corresponding to the environmental sensor sending the environmental condition message when each environmental condition message is out of the corresponding environmental condition range (205).

The above-mentioned method can be further illustrated by the following example. After any power socket 11 of the PDU 10 is plugged in by an air conditioner for adjusting room temperature and the PDU 10 is connected to a network to handshake and connect with an environmental sensor 20 for sensing room temperature, an environmental condition message (temperature values) generated after the environmental sensor 20 senses a room temperature is transmitted to the PDU 10 through the network. The PDU 10 provides an environmental condition range (temperature range) associated with the environmental sensor 20 including an upper temperature bound (for example 40° C.) and a lower temperature bound (for example 35° C.). The upper and lower temperature bounds serve as criteria for the PDU 10 to power on and power off the air conditioner. For example, if the room temperature is above the upper temperature bound, the PDU 10 starts supplying power to the power socket 11 connected to the air conditioner and the air conditioner starts operating to lower the room temperature. Meanwhile, the environmental sensor 20 constantly senses the room temperature and keeps sending environmental condition messages to the PDU 10. Before the room temperature is below the lower temperature bound, the PDU 10 continuously supplies power to the air conditioner until the PDU 10 detects that the environmental condition messages sent from the environmental sensor 20 is below the lower temperature bound. Since the room temperature is effectively dropped below a lower temperature bound, the PDU then stops supplying power to the air conditioner. When the environmental condition messages sent from the environmental sensor are higher than the upper temperature bound again, the PDU 10 restarts activating the air conditioner.

Besides connecting each environmental sensor 20 through a network, the PDU 10 further provides a web page having an HTML format for multiple computers to connect with and browse the web page through the network so that managers with right priorities can add new environmental sensors or set the environmental condition range of each environmental sensor through the web page provided by the PDU 10.

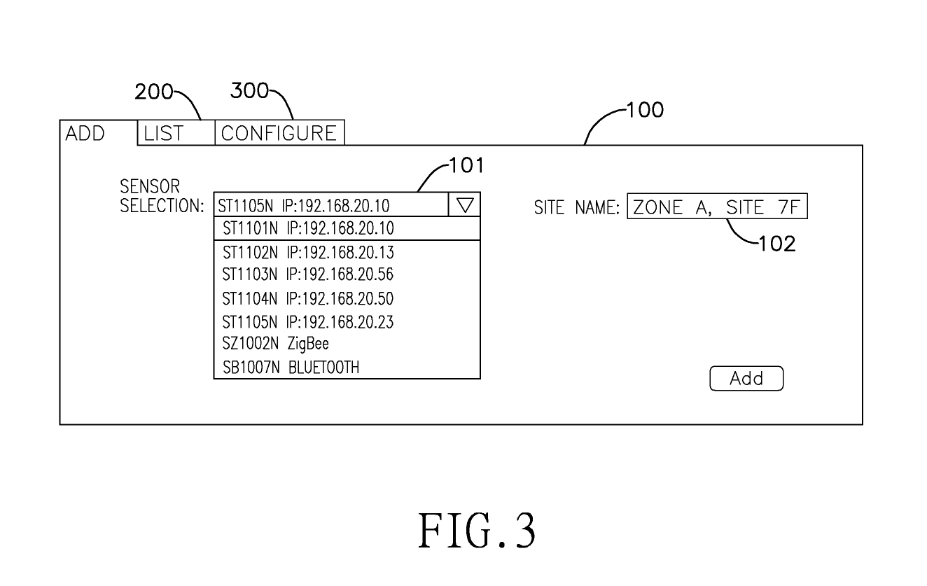

With reference to FIG. 3, the content of the web page has a new equipment tab 100, an equipment list tab 200 and a setting tab 300.

The new equipment tab 100 has a new equipment field 101 and an equipment name field 102. The new equipment field 101 allows user to input identification information of a new environmental sensor. The identification information may be an IP address, a MAC address or a serial number of the new environmental sensor. In the present embodiment, the identification information entered in the new equipment field 101 is an IP address of the new environmental sensor. The equipment name field 102 allows users to enter a name of the new environmental sensor.

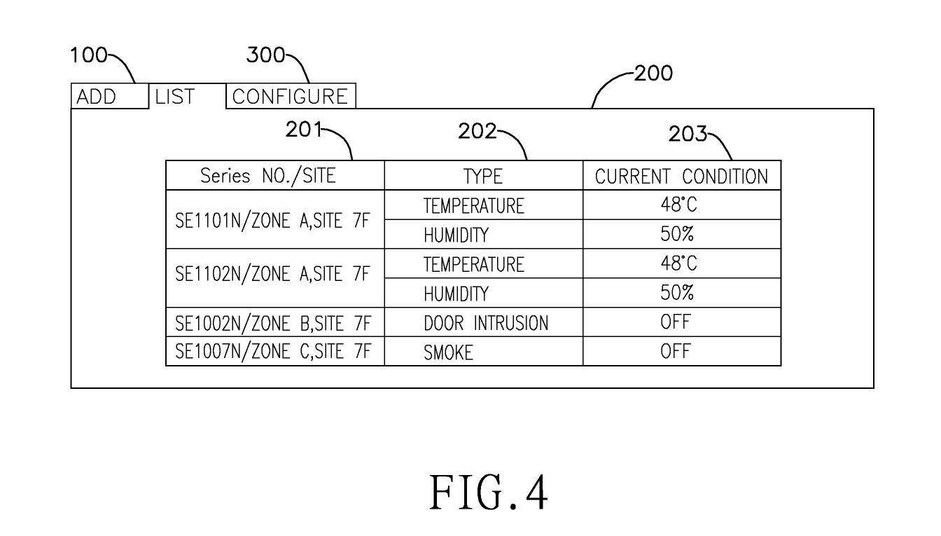

With reference to FIG. 4, the equipment list tab 200 lists environmental sensors connected with the PDU 10 and has an equipment name column 201, an equipment type column 202 and a current condition column 203.

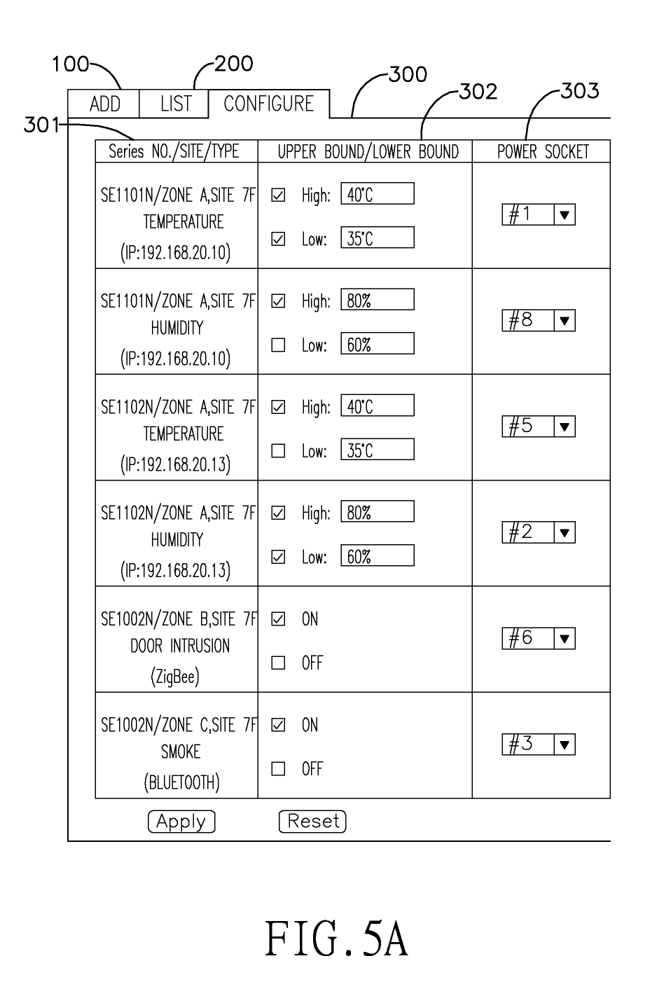

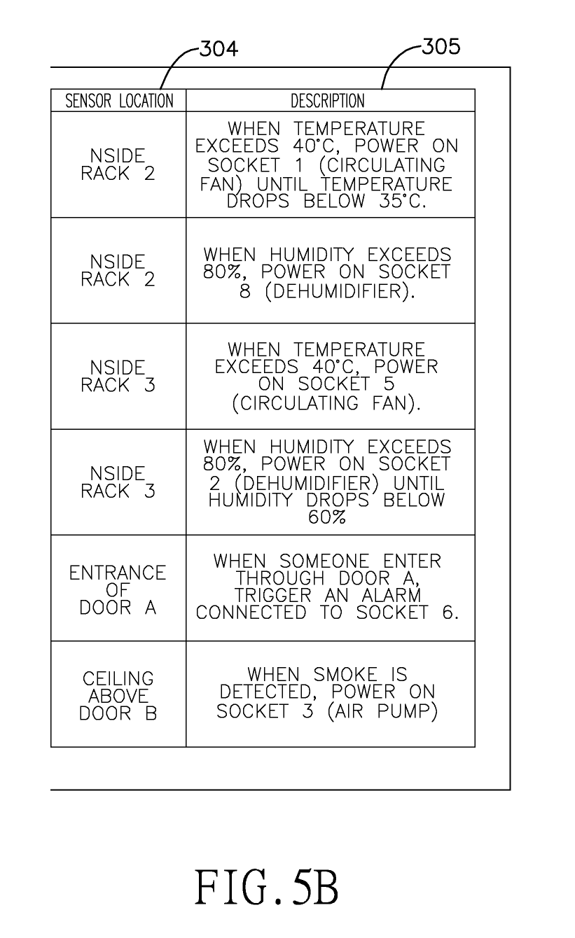

With reference to FIGS. 5A and 5B, the setting tab 300 provides a table having an equipment name column 301 (including serial number, name and type), a setting column 302, a power socket number column 303, an equipment location column 304 and a remark column 305. Given the aforementioned columns, users can set up the environmental condition range of each environmental sensor. Take the first environmental sensor in the equipment name column 301 as an example, which is a temperature sensor named “SE1101N/Site 7F Area A”. The setting column 302 allows users to set the upper temperature bound and the lower temperature bound of the temperature sensor. For example, the upper temperature bound is set to be 40° C. and the lower temperature bound is set to be 35° C. The power socket number column 303 allows users to designate a power socket corresponding to the temperature sensor. In other words, the PDU 10 starts or stops supplying power to the designated power socket when the room temperature sensed by the temperature sensor is above 40° C. or below 35° C. The equipment location column 304 is used to locate the temperature sensor in the site. The remark column 305 serves to describe how the PDU operates with the environmental condition messages sent from the temperature sensor.

The method of the present invention allows a PDU to receive environmental condition messages sent from external environmental sensors and power on or power off respective power-consuming devices after determining if the environmental condition messages are out of bound. Accordingly, the environmental condition happening in the site can be tackled immediately, thereby eliminating the need of a master control center for monitoring and controlling various on-site environmental sensors.

Additionally, the web page provided by a PDU allows managers with right priority to add and set environmental sensors through non-specific type of computers so that one-on-one correspondence does not necessarily exist between the PDU and the environmental sensors, and one PDU can correspond to multiple environmental sensors. In case of a faulty environmental sensor, the PDU can be selectively set to correspond to other working environmental sensors in the proximity of the faulty one. On the other hand, a mapping relationship between multiple PDUs and one environmental sensor can be also supported. For example, usually a smoke detector is mounted on a ceiling while the emergency smoke exhaust fan may not be around the smoke detector. If two emergency smoke exhaust fans are mounted on the windows over the east side and west side of a building, two PDUs mounted on east side and west side of the building can control the two emergency smoke exhaust fans. The PDUs on the east side and west side can be simultaneously connected to a smoke detector on the ceiling of the site and receive the smoke sensing message sent from the smoke detector. In case of a fire, both PDUs on the east side and the west side can power on the emergency smoke exhaust fans to evacuate smoke and the PDU can be flexibly arranged in terms of location and operation.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A method for creating virtual environmental sensor on a power distribution unit executed by a power distribution unit and comprising steps of:
connecting to a network and at least one power-consuming device;
searching all environmental sensors connected to the network and mapping each environmental sensor to one of the at least one power-consuming device;
receiving environmental condition messages sent from each environmental sensor;
presenting at least one environmental condition range to determine if the environmental condition messages sent from each environmental sensor are out of one of the at least one environmental condition range; and
powering on or off the power consuming device corresponding to the environmental sensor sending the environmental condition message when each environmental condition message is out of a corresponding environmental condition range.

2. The method as claimed in claim 1, wherein the power distribution unit provides a web page for multiple computers to connect with and browse the web page through the network, and the web page has:
a new equipment tab having a new equipment field for inputting identification information of a new environmental sensor;
an equipment list tab listing the environmental sensors connected with the power distribution unit; and
a setting tab having a setting column for respectively setting the at least one temperature range and for determining if each environmental condition message is out of a corresponding temperature range.

3. The method as claimed in claim 2, wherein the new equipment tab further has an equipment name field for entering a name of a new environmental sensor.

4. The method as claimed in claim 2, wherein the identification information is an IP address, a MAC address or a serial number of the new environmental sensor.

5. The method as claimed in claim 4, wherein the setting tab has a table having the setting column and further having an equipment name column and a power socket number column.

6. The method as claimed in claim 5, wherein the table further has an equipment location column and a remark column.

7. The method as claimed in claim 1, wherein the environmental sensor is a temperature sensor, a humidity sensor, a smoke detector or a door sensor.

8. The method as claimed in claim 2, wherein the environmental sensor is a temperature sensor, a humidity sensor, a smoke detector or a door sensor.

9. The method as claimed in claim 3, wherein the environmental sensor is a temperature sensor, a humidity sensor, a smoke detector or a door sensor.

10. The method as claimed in claim 4, wherein the environmental sensor is a temperature sensor, a humidity sensor, a smoke detector or a door sensor.

11. The method as claimed in claim 5, wherein the environmental sensor is a temperature sensor, a humidity sensor, a smoke detector or a door sensor.

12. The method as claimed in claim 6, wherein the environmental sensor is a temperature sensor, a humidity sensor, a smoke detector or a door sensor.
